(19) United States
(12) Patent Application Publication
(10) Pub. No.: US 2026/0195641 A1
(43) Pub. Date: Jul. 9, 2026

(54) SYSTEM AND METHODS FOR PREDICTIVE MODELING BASED UPON MULTIMODAL GEOTAGGED DATA

(71) Applicant: State Farm Mutual Automobile Insurance Company, Bloomington, IL (US)

(72) Inventors: Hanpei ZHANG, Mesa, AZ (US); Christian T. KANG, Normal, IL (US)

(73) Assignee: State Farm Mutual Automobile Insurance Company, Bloomington, IL (US)

(21) Appl. No.: 19/039,072

(22) Filed: Jan. 28, 2025

Related U.S. Application Data
(60) Provisional application No. 63/742,713, filed on Jan. 7, 2025.

(51) Int. Cl. G06N 20/00

(52) U.S. Cl. CPC G06N 20/00

(57) ABSTRACT

Systems and methods for utilizing geotagged data for predictive modeling are disclosed. The method may include, such as by one or more processors, transceivers, and/or sensors: (1) receiving a first set of geotagged data from devices associated with a user; (2) processing data received from data sources for supplemental data corresponding to locations in the first set of geotagged data; (3) inputting the first set of geotagged data and the supplemental data into a machine-learning model, wherein the machine-learning model is trained to generate (i) an event prediction corresponding to event occurrences at the locations, and/or (ii) recommendations corresponding to the predicted events; (4) generating a risk profile for the locations based upon a frequency of the event occurrences of the predicted events; and/or (5) presenting a visual and/or audible prediction presentation based upon the event prediction, the risk profile, and/or the recommendations to user via a user device.

### CROSS-REFERENCE TO RELATED APPLICATION

This patent application claims the benefit of priority to U.S. Provisional Application No. 63/742,713, filed on Jan. 7, 2025, the entirety of which is incorporated herein by reference.

### TECHNICAL FIELD

This present disclosure relates generally to the field of data analytics and machine-learning. In particular, the present disclosure relates to utilizing geotagged data for predictive modeling, risk assessment, and generating actionable insights for event-driven risk management.

### BACKGROUND

Conventional techniques for analyzing spatial and temporal insights based upon geotagged data are often hindered by the inability to effectively process and integrate a diverse, unstructured data stream. For example, social media platforms may produce vast quantities of multimodal data (e.g., text, images, video, and audio) that may often be accompanied by geospatial metadata and timestamps. Conventional data analytics approaches, such as keyword-based search or basic clustering, may be insufficient to capture nuanced relationships between these diverse data types to produce timely, actionable insights.

Conventional batch processing approaches, which may rely upon analyzing historical datasets, may introduce latency that may undermine the relevance of predictions related to real-time events. For example, traditional approaches may typically utilize historical data and localized reporting systems, which can be sparse, outdated, or incomplete. This may result in incomplete or imprecise interpretations, where the full context of an event, including its geographic and temporal significance, may be lost.

The heterogeneity and sparsity of geotagged data may further complicate this process, as social media posts are unevenly distributed across geographic areas, leading to skewed insights and challenges in accurately assessing risks or predicting future events in real-time. Traditional methods often struggle to provide real-time insights, which may be crucial for responding to rapidly evolving events like natural disasters, accidents, or public safety threats.

Additionally, the isolated use of datasets, such as weather data, emergency services reports, or geospatial maps, may result in a fragmented risk assessment that may fail to account for the dynamic and multimodal nature of real-world events. Conventional techniques may include other ineffectiveness, encumbrances, inefficiencies, and drawbacks, as well.

### SUMMARY

The present embodiments may relate, inter alia, to real-time data analytics and predictive modeling using geotagged multimodal data, such as those discussed above and elsewhere herein. Specifically, the present computer systems and computer-implemented methods may solve technical challenges by leveraging machine-learning models to process and integrate diverse, unstructured geotagged data types (e.g., text, audio, images, and/or videos) enriched with supplemental data, such as environmental datasets and Internet of Things (IoT) sensor readings. The systems address limitations in conventional methods by dynamically categorizing and ranking event severity across shared geographic areas, continuously analyzing high-velocity data feeds utilizing machine-learning to refine predictions, and generating actionable risk assessments and predictions that may adapt to rapidly evolving conditions.

In one aspect, a computer-implemented method for utilizing geotagged data for predictive modeling may be provided. The computer-implemented method may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another and operate as input and/or output devices. In one instance, the computer-implemented method may be performed by one or more local or remote processors of a computing system in communication with one or more local or remote data sources.

The computer-implemented method may include, via one or more local or remote processors, transceivers, sensors, servers, and/or other components: (1) receiving, by the one or more processors, a first set of geotagged data from one or more devices associated with a user; (2) processing, by the one or more processors, data received from the one or more data sources for supplemental data corresponding to one or more locations in the first set of geotagged data; (3) inputting, by the one or more processors, the first set of geotagged data and the supplemental data into a machine-learning model, wherein the machine-learning model is trained to generate: (i) an event prediction corresponding to one or more event occurrences at the one or more locations, and/or (ii) one or more recommendations corresponding to the one or more predicted events; (4) generating, by the one or more processors, a risk profile for the one or more locations based upon a frequency of the one or more event occurrences of the one or more predicted events; and/or (5) outputting (such as via visual, graphical, textual, audible, verbal, and/or other outputs), by the one or more processors, a prediction presentation based upon the event prediction, the risk profile, and the one or more recommendations to one or more user interfaces of the one or more devices associated with the user. The method may include additional, less, or alternate functionality, including that discussed elsewhere herein.

In another aspect, a computer system for utilizing geotagged data for predictive modeling may be provided. The computer system may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another. In one instance, the computer system may be performed by one or more local or remote processors of a computing system in communication with one or more local or remote data sources, and at least one non-transitory computer readable medium storing instructions which, when executed by the one or more processors, cause the one or more processors to perform certain operations.

The computer system may include, via one or more processors, non-transitory computer readable medium, transceivers, sensors, servers, and/or other components to perform operations that may include: (1) receiving a first set of geotagged data from one or more devices associated with a user; (2) processing data received from the one or more data sources for supplemental data corresponding to one or more locations in the first set of geotagged data; (3) inputting the first set of geotagged data and the supplemental data into a machine-learning model, wherein the machine-learning model is trained to generate: (i) an event prediction corresponding to one or more event occurrences at the one or more locations, and/or (ii) one or more recommendations corresponding to the one or more predicted events; (4) generating a risk profile for the one or more locations based upon a frequency of the one or more event occurrences of the one or more predicted events; and/or (5) outputting a prediction presentation based upon the event prediction, the risk profile, and the one or more recommendations to one or more user interfaces of the one or more devices associated with the user. The system may include additional, less, or alternate functionality, including that discussed elsewhere herein.

In yet another aspect, a non-transitory computer readable medium for utilizing geotagged data for predictive modeling may be provided. The non-transitory computer readable medium may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another. In one instance, the non-transitory computer readable medium may be performed by one or more local or remote processors of a computing system in communication with one or more local or remote data sources, and at least one non-transitory computer readable medium storing instructions which, when executed by the one or more processors, cause the one or more processors to perform certain operations.

The non-transitory computer readable medium may include, via one or more processors, transceivers, sensors, servers, and/or other components: (1) receiving a first set of geotagged data from one or more devices associated with a user; (2) processing data received from the one or more data sources for supplemental data corresponding to one or more locations in the first set of geotagged data; (3) inputting the first set of geotagged data and the supplemental data into a machine-learning model, wherein the machine-learning model is trained to generate (i) an event prediction corresponding to one or more event occurrences at the one or more locations, and (ii) one or more recommendations corresponding to the one or more predicted events; (4) generating a risk profile for the one or more locations based upon a frequency of the one or more event occurrences of the one or more predicted events; and/or (5) outputting a prediction presentation based upon the event prediction, the risk profile, and the one or more recommendations to one or more user interfaces of the one or more devices associated with the user. The operations may include additional, less, or alternate functionality, including that discussed elsewhere herein.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 depicts a diagram showing an exemplary architecture diagram for processing geotagged multimodal data to generate real-time risk assessments and predictive insights, according to certain aspects of the disclosure.

FIG. 2A is an exemplary flowchart of a computer-implemented or computer-based process for analyzing geotagged data to generate predictions and recommendations, according to one or more embodiments.

FIG. 2B depicts a diagram showing an exemplary disaster intel dashboard, according to one or more embodiments.

FIG. 3 shows an exemplary machine-learning training flow chart, according to one or more embodiments.

FIG. 4 illustrates an implementation of an exemplary computer system that executes one or more techniques presented herein.

Advantages will become more apparent to those skilled in the art from the following description of the preferred embodiments that have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

The present embodiments may relate, inter alia, to computer systems and computer-implemented methods that may process, integrate, and analyze geotagged multimodal data (e.g., text, audio, images, and/or videos) in combination with external data (e.g., environmental data, IoT sensor readings, etc.) to generate real-time, spatiotemporal insights, risk assessments, and actionable predictions tailored to evolving events. By addressing challenges, such as data heterogeneity, scalability, and rapid adaptation to changing conditions, the present embodiments may support enhanced decision-making for disaster management, public safety, and other event-driven applications.

Processing geotagged data may present unique challenges that conventional methods often struggle to address effectively. The inherent complexity of geotagged data, which may combine diverse modalities, such as text, images, audio, and video data linked to specific locations, may need sophisticated processing techniques. Traditional methods, however, are typically designed for structured or uniform datasets and may lack the flexibility needed to handle this diversity of data. For example, these methods may often fail to integrate multimodal data effectively, leading to incomplete or inaccurate insights.

Geotagged data often reflects unfolding events and circumstances. Traditional systems, which are generally designed for batch processing, may be technically challenged to process such geotagged data in real-time. This lag in analysis may hinder timely decision-making, particularly in critical applications such as disaster response or public safety, where immediate insights are important.

Conventional systems may often lack the technical capability to contextualize geotagged data effectively. Location-based data is rich in context, but extracting meaningful insights may depend on the correlation of spatial and temporal information with external data sources, such as weather reports, IoT device data, and/or historical event logs. Traditional approaches frequently operate in silos, making it challenging to integrate these external datasets seamlessly. This may result in fragmented analyses that may fail to capture the full picture.

The proliferation of social media platforms and IoT devices has led to an explosion in data volume, much of which may be unstructured. Traditional data processing pipelines are not optimized for this scale and complexity, leading to performance bottlenecks and resource inefficiencies. Furthermore, geotagged data may often include sensitive information, such as a user's location or activities. Conventional methods may lack robust mechanisms for ensuring data anonymization or compliance with privacy regulations, which makes the use of such methods in sensitive applications problematic.

### Exemplary Computer System

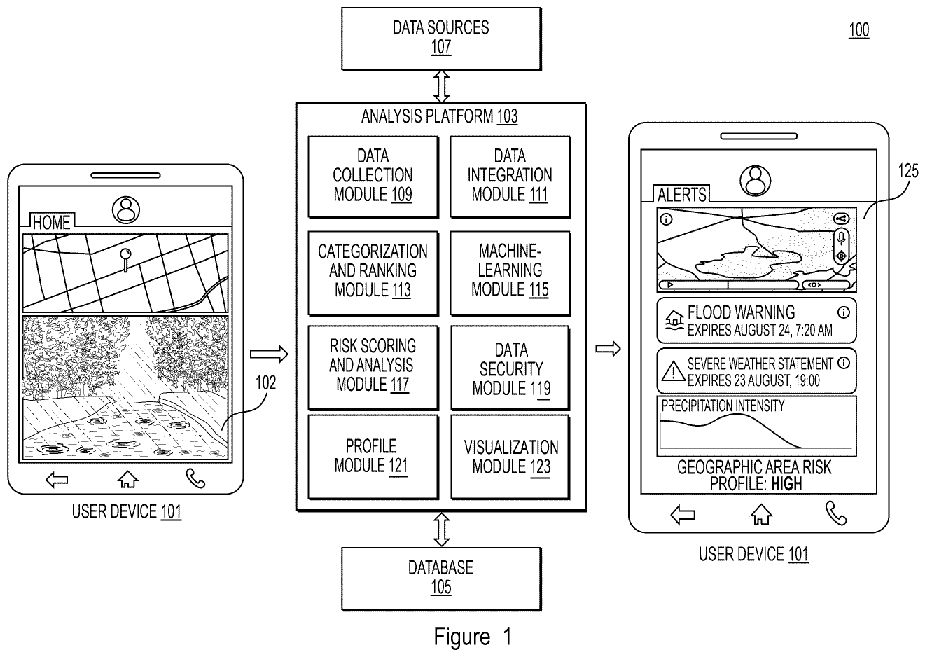

To address technical challenges, such as the above, computing system 100 of FIG. 1 may integrate machine-learning technologies with advanced data handling and contextual analysis techniques. By leveraging geotagged multimodal data, the computing system 100 may provide a scalable and intelligent approach for real-time risk assessment and predictive modeling.

The computing system 100 may employ a modular architecture capable of harmonizing geotagged data across different modalities. The computing system 100 may categorize and rank the incoming data, assign severity levels, and extract actionable insights. Machine-learning techniques may identify patterns in multimodal data, resulting in improving the system's ability to predict future events based upon historical trends and contextual factors. This may ensure that the nuances of each data type are preserved and incorporated into the analysis for accurate assessment.

To address the lag inherent in traditional batch processing systems, the computing system 100 may employ real-time data ingestion and analysis mechanisms. The computing system 100 may continuously process geotagged inputs as they are received, correlating them with external data sources (e.g., IoT device readings, weather reporting, historical event logs, etc.). By using machine-learning models to dynamically adjust predictions based upon incoming data, the computing system 100 may ensure that insights are generated promptly, empowering users to respond swiftly to evolving events, such as natural disasters or public safety emergencies.

The computing system 100 may contextualize geotagged data by integrating supplemental information from external databases. For instance, the system may access location-specific weather conditions, historical risk patterns, and IoT device data and may utilize the data to enrich the analysis. Machine-learning algorithms may analyze the external data alongside the geotagged data to generate accurate and contextual risk assessments.

To overcome the scalability challenges faced by conventional methods, the computing system 100 may be built upon a robust, distributed processing framework. This architecture may be optimized for high throughput, enabling the computing system 100 to process vast amounts of geotagged data from multiple users and sources simultaneously. Furthermore, by recognizing the sensitivity of geotagged data, the computing system 100 may incorporate privacy-preserving mechanisms (e.g., data encryption, data tokenization, etc.), secure transmission protocols, and compliance with regulatory standards.

FIG. 1 depicts a diagram showing an exemplary architecture diagram for processing geotagged multimodal data to generate real-time risk assessments and predictive insights, according to certain aspects of the disclosure. FIG. 1 may include the computing system 100 that may include a user device 101, an analysis platform 103, a database 105, and data sources 107. It should be understood that other implementations of computing system 100 may omit one or more of the foregoing components and/or may include additional components, as the case may be.

In one instance, the user device 101 may include, but is not restricted to, any type of mobile terminal, wireless terminal, fixed terminal, or portable terminal. Examples of the user device 101 may include hand-held computers, desktop computers, laptop computers, wireless communication devices, cell phones, smartphones, mobile communications devices, a Personal Communication System (PCS) device, tablets, server computers, gateway computers, or any combination thereof, including the accessories and peripherals of these devices, or any combination thereof. In one instance, users may upload or share geotagged multimodal data (e.g., textual posts, images, audio recordings, and/or videos) from their devices (e.g., user device 101). For example, a user in a flood-affected area may upload a video showing rising water levels and the user may provide a brief textual description of the road conditions (e.g., via user interface 102). The geotagged data may be tagged with precise location coordinates and may provide situational insights that are useful for predicting events and assessing risks in the vicinity. The geotagged data may be seamlessly transmitted to the analysis platform 103, whereupon the analysis platform 103 may analyze the geotagged data alongside other relevant data sources, in order to generate up-to-date risk assessments and predictive insights.

In one instance, the analysis platform 103 may include a platform with multiple interconnected components. The analysis platform 103 may include one or more servers, intelligent networking devices, computing devices, components, and/or corresponding software for processing geotagged multimodal data, integrating supplemental data, categorizing and ranking event(s) based upon severity, assigning contextual risk profiles, and/or generating predictions. The analysis platform 103 may leverage advanced data processing techniques to harmonize diverse data types (e.g., text, audio, video, and/or images) and incorporate real-time contextualization through dynamic correlation with external sources, including weather databases, IoT sensors, and/or historical event records. The analysis platform 103 may utilize trained machine-learning models for determining dynamic predictions by analyzing historical and real-time data to identify patterns, classify events, and/or recommend contextually relevant actions. The predictions may be refined by iteratively learning from the data streams, allowing for adaptive risk assessments and tailored insights.

In one instance, the analysis platform 103 may include a data collection module 109, a data integration module 111, a categorization and ranking module 113, a machine-learning module 115, a risk scoring and analysis module 117, a data security module 119, a profile module 121, and a visualization module 123, or any combination thereof. As used herein, terms such as “component” or “module” generally encompass hardware and/or software, e.g., that a processor or the like used to implement associated functionality. It is contemplated that the functions of these components are combined in one or more components or performed by other components of equivalent functionality.

In one instance, the data collection module 109 may collect, in real-time, geotagged multimodal data from a plurality of sources (e.g., user device 101, database 105, data sources 107, etc.). The data collection module 109 may use a web-crawling component to access the plurality of sources to collect relevant data associated with the geotagged data. Alternatively or additionally, the data collection module 109 may include various software applications (e.g., data mining applications in Extended Meta Language (XML)), that may automatically search for and return relevant data regarding the geotagged data.

The data collection module 109 may employ specialized preprocessing algorithms tailored to each data type. For textual data, the data collection module 109 may utilize natural language processing (NLP) to extract key phrases, sentiments, and contextual meanings. In one example, NLP may identify key phrases by employing techniques like part-of-speech (POS) tagging, named entity recognition (NER), or machine-learning techniques. NLP may identify the emotional tone of the text by utilizing pre-defined dictionaries of words with associated sentiment scores to calculate overall sentiment or trained classifiers (e.g., logistic regression, BERT, etc.) on labeled dataset to recognize patterns indicative of sentiment NLP may derive contextual meaning by capturing relationships between words and their usage within the text. In such a manner, NLP may facilitate the data collection module 109 to process unstructured text effectively. The data collection module 109 may apply computer vision algorithms upon images and/or videos to analyze visual content and identify objects, activities, and/or environmental conditions. To transcribe and process audio data, the data collection module 109 may use speech recognition and/or sentiment analysis techniques.

The geotagged data may be embedded with location data, such as GPS coordinates and timestamps, for precise spatial and temporal context. The data collection module 109 may process, parse, and/or arrange the collected data into a common format that is easily processed by other modules and platforms. The data collection module 109 may also detect corrupt or inaccurate data and may replace, modify, or delete the corrupt or inaccurate data.

In one instance, the data integration module 111 may enrich the geotagged data with supplemental information (e.g., environmental data, historical data, situational data, etc.) from diverse external sources (e.g., data sources 107) to provide comprehensive and contextually accurate insights for risk assessment and prediction. In one example, the data integration module 111 may match the geotagged location with current weather conditions within a predefined distance threshold to assess environmental factors that may influence an event. In another example, the data integration module 111 may integrate IoT sensor data to provide insights into property status, vehicle activity, or other situational details. In a further example, the data integration module 111 may analyze patterns from past incidents in the same location (e.g., comparing the frequency of past natural disasters in the region to assess risk levels, analyzing historical crime data to evaluate safety concerns, etc.) to predict potential outcomes. The data integration module 111 may also link the geotagged location with traffic data to assess traffic congestion or potential hazards.

In another instance, the data integration module 111 may perform semantic mapping by extracting contextual meaning to create relationships between disparate datasets. For example, the data integration module 111 may map a geotagged post mentioning “flooded streets” to flood warnings from government agencies and nearby water level sensor data.

In one instance, the categorization and ranking module 113 may classify and prioritize geotagged data for effective risk assessment. Initially, the categorization and ranking module 113 may analyze the geotagged data using various techniques. For example, for textual data, NLP techniques may be utilized to identify keywords, context, and/or sentiment, to determine whether the post refers to events like storms, accidents, and/or social gatherings. For visual and audio data, computer vision and audio analysis algorithms may be used to extract features, such as objects, movements, and/or sounds (e.g., detecting flood or fire from images or videos) from the geotagged data. The geotagged data may be categorized into predefined event types, such as natural disasters, safety hazards, public events, and so on.

Once the data is classified, the categorization and ranking module 113 may rank the geotagged data based upon severity, considering a combination of factors to assess the potential impact of each event. Key factors may include the frequency of similar events in the location, which may facilitate in determining whether the event is an isolated occurrence or part of a larger pattern. For example, if a geotagged post indicates a flood in a region where flooding has been reported frequently, the event's severity may be ranked higher due to its reoccurrence. Additionally, the scale of the incidents may be considered, which may include the geographic spread, the number of individuals affected, and/or the potential for widespread damage. For example, a large-scale earthquake that may potentially impact a wider population and infrastructure may be ranked higher due to its impact.

In one instance, external indicators (e.g., weather alerts or IoT device data) may further influence the ranking. For example, if a severe weather warning or IoT sensors detect a rising threat (e.g., rapidly escalating wind speed or rising water levels), the categorization and ranking module 113 may adjust the ranking of a related event (e.g., a storm or a flood) to reflect the increased risk. This dynamic assessment may allow for prioritization of high-impact events, such as natural disasters, over less critical occurrences, ensuring that the most urgent risks are highlighted for immediate attention and intervention. The categorized and ranked geotagged data may be input into the machine-learning module 115 for a predictive analysis.

In one instance, the machine-learning module 115 may be configured for supervised machine-learning and utilizing training data (e.g., training data 312 illustrated in the training data flow 300). The trained model may be configured for analyzing the categorized and ranked geotagged data to provide predictive insights and recommended actions. In one example, the machine-learning module 115 may perform model training using training data (e.g., data from other modules, which may include input and correct output, to allow the model to learn over time). The training may performed based upon the deviation of a processed result from a documented result when the inputs are fed into the machine-learning model (e.g., an algorithm may measure its accuracy through the loss function, adjusting until the error has been sufficiently minimized). The machine-learning module 115 may randomize the ordering of the training data, visualize the training data to identify relevant relationships between different variables, identify any data imbalances, and split the training data into two parts, where one part may be for training a model and the other part may be for validating the trained model, de-duplicating, normalizing, correcting errors in the training data, and so on.

In one instance, the machine-learning module 115 may detect patterns and trends within the geotagged data to forecast potential risks or events with high accuracy. The machine-learning module 115 may process the input data through a combination of feature extraction, data preprocessing, and model inference. Key features, such as event frequency, severity ranking, and environmental conditions may be extracted and fed into trained machine-learning models. The trained machine-learning models may identify relationships between geotagged data and potential risks. For example, a high probability of a flood event in a specific area can be predicted based upon real-time geotagged posts, weather patterns, past incidents, and/or IoT sensors detecting rising water levels. Once predictions are generated, the machine-learning module 115 may assign confidence scores to each prediction and may correlate the confidence scores with geographic zones, highlighting areas with higher risk levels. The machine-learning module 115 may generate real-time alerts and recommendations for mitigation or response actions, such as suggesting evacuation measures during a natural disaster. For example, in the flooding example, the machine-learning module 115 may trigger alerts to the users, suggest evacuation routes, and/or notify relevant authorities for immediate action.

Additionally, the machine-learning module 115 may support iterative learning by incorporating feedback loops. For instance, the outcome of risk predictions and user responses to recommendations may be analyzed to refine the accuracy of the machine-learning models. By integrating data-driven predictions with real-time contextual information, the machine-learning module 115 may enhance the system's ability to respond proactively to dynamic and complex scenarios.

In one instance, the risk scoring and analysis module 117 may quantify and evaluate the level of risk associated with specific locations or events based upon the predictions generated by the machine-learning module 115. The risk scoring and analysis module 117 may take into account multiple inputs, including the categorized data, severity rankings, event predictions, and/or supplemental contextual information, in order to generate a comprehensive risk score for each identified event or geographic area. These scores may serve as actionable metrics for stakeholders, enabling the stakeholders to prioritize resources, plan mitigation strategies, and/or respond effectively to potential risks.

The risk scoring and analysis module 117 may aggregate data from various sources, including event predictions, historical incident patterns, environmental conditions, and/or demographic factors. Each data input may be assigned a weight based upon its relevance to the event type and potential impact. For example, in the case of a predicted hurricane, weather data and IoT sensors may be weighted more heavily than social media activity. The aggregated data may be processed through a risk-scoring algorithm that may compute a score for each event or location. The risk scoring and analysis module 117 may compare the risk scores against predefined thresholds to classify events or locations into risk categories such as low, moderate, high, or critical. In one example, the geotagged data may indicate a series of posts mentioning “fire” in a forested area. The machine-learning module 115 may predict a potential wildfire event, with additional inputs such as wind speed and humidity levels from weather data. The risk scoring and analysis module 117 may assign a high-risk score to this location based upon (i) severity ranking of wildfire as a critical event, (ii) weather conditions conducive to rapid fire spread, and/or (iii) proximity to residential areas and critical infrastructures.

In one instance, the data security module 119 may ensure the security and privacy of geotagged data and associated user information. The data security module 119 may perform data encryption using advanced encryption standards (AES) for sensitive data, such as personally identifiable information, location coordinates, and other confidential details. Additionally, the data security module 119 may employ tokenization techniques to replace sensitive data with unique identifiers, making the sensitive data unusable to unauthorized parties. The encrypted and tokenized data may ensure compliance with privacy regulations, protecting user data while enabling the secure sharing of anonymized information across various system components.

In one instance, the profile module 121 may generate a dynamic profile for specific geographic areas based upon the frequency and/or severity of events occurring in those regions. The profile module 121 may continuously analyze geotagged data to track the occurrence of specific events, such as natural disasters, public safety incidents, and/or environmental changes to generate a profile for each geographic region. The profile may be updated, in real-time, based upon the accumulation of events and the evolving risks. The profile may include metrics, such as event frequency, severity levels, and/or historical trends, which may be crucial for predicting future occurrences and assessing risk in the region. The profile may be used by the system to enhance predictive modeling and decision-making processes for risk management, insurance assessment, and/or disaster response.

In one instance, the visualization module 123 may transform raw data and analysis outputs into visually rich, interactive representations, thereby enabling users to quickly understand the scope, severity, and geographic distribution of events and risks. In one example, the visualization module 123 may generate interactive maps that may provide a real-time overview of event predictions and associated risk levels (e.g., user interface 125). The geographic location may be visually marked with icons or heatmaps to represent the predicted events, severity ranking, and risk scores. In another example, the visualization module 123 may generate a display of a dashboard that may include a range of data metrics, including event frequency, risk scores, and/or trends over time. The dashboard may be customizable, allowing users to filter data by event type, location, or risk level. In a further example, the visualization module 123 may provide visual timelines that may outline the expected progression of the event. The projections may include potential impact zones, escalation patterns, and recommended actions.

The visualization module 123 may employ various application programming interfaces (APIs) or other function calls corresponding to the application upon the user device 101, thus enabling the display of graphics primitives such as graphs, edges, icons, menus, buttons, data entry fields, (e.g., user interfaces 102 and 125). The visualization module 123 may also comprise a variety of interfaces, for example, interfaces for data input and output devices, referred to as I/O devices, storage devices, and the like. Still further, the visualization module 123 may be configured to operate in connection with augmented reality (AR) processing techniques, wherein various applications, graphic elements, and features interact.

In one instance, the database 105 may include any type of database, such as relational, hierarchical, object-oriented, and/or the like, wherein data may be organized in any suitable manner, including data tables or lookup tables. The database 105 may serve as a structured repository for storing, organizing, and managing data efficiently, enabling quick retrieval and manipulation of information. For example, the database 105 may store, manage, and/or retrieve geotagged multimodal data and supplemental data.

The database 105 may incorporate geospatial indexing, hierarchical categorization, and/or integration with external APIs for enriched analysis. It may utilize a relational model to establish relationships between data entities, ensuring that related data can be easily accessed and queried. The database 105 may support seamless interaction with other system components by categorizing data, enabling real-time retrieval for predictive modeling, risk scoring, and visualization, and archiving processed data with audit logs for accountability.

Additionally, the database 105 may implement advanced query optimization and facilitate robust tokenizing and encryption for high performance, data security, and/or regulatory compliance. In one example, the analysis platform 103 may replace sensitive data elements with unique, non-sensitive tokens, ensuring that raw data is not exposed during storage or processing. In another example, the analysis platform 103 may secure data in transit and at rest using cryptographic algorithms, safeguarding data against unauthorized access and breaches. The database 105 may store the tokenized and/or encrypted data for further processing.

In one instance, data sources 107 may include a variety of data sources that may provide comprehensive and contextually relevant data. The data sources 107 may include:
(i) Weather database: real-time and historical weather data providing details upon conditions like rainfall, wind speeds, earthquakes, storm warnings, etc. ;
(ii) IoT devices: sensors embedded in vehicles, homes, or public infrastructure that may collect real-time environmental data, such as temperature, humidity, vibration, and motion;
(iii) Public and government databases: datasets from organizations like the Federal Emergency Management Agency (FEMA) or city planning departments offering structured information upon historical incidents, safety codes, or event permits;
(iv) Private databases: historical claims data maintained by insurance companies, and/or information about power outages, and infrastructure damage from utility companies;
(v) Video and audio feeds: inputs from surveillance cameras, drones, or user-shared videos providing real-time data upon evolving situations in a specific location; and

(vi) Other public and/or private databases, such as social media feeds and outlets, such as Facebook, Twitter, YouTube, etc.

By incorporating these elements from the data sources 107, the computing system may ensure that diverse, high-quality data are available. It should be understood that data sources 107 may include any other databases that provide relevant information pertaining to the geotagged data.

The various elements of the computing system 100 may communicate with each other through a communication network. In one instance, the user device 101 may include a network detection sensor for detecting wireless signals or receivers for different communications (e.g., Bluetooth, Wi-Fi, Li-Fi, near field communication (NFC), etc.) from the communication network. The communication network may support a variety of different communication protocols and communication techniques.

In one instance, the communication network may allow the user device 101 (or one or more user devices) to communicate with the analysis platform 103. The communication network may include one or more networks such as a data network, a wireless network, a telephony network, or any combination thereof. It is contemplated that the data network is any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network is, for example, a cellular communication network and employs various technologies including 5G (5th Generation), 4G, 3G, 2G, Long Term Evolution (LTE), wireless fidelity (Wi-Fi), Bluetooth®, Internet Protocol (IP) data casting, satellite, mobile ad-hoc network (MANET), vehicle controller area network (CAN bus), and the like, or any combination thereof.

The above presented modules and components of the analysis platform 103 may be implemented in hardware, firmware, software, or a combination thereof. Though depicted as a separate entity in FIG. 1, it is contemplated that the analysis platform 103 may be implemented for direct operation by the respective user device 101. As such, the analysis platform 103 may generate direct signal inputs by way of the operating system of the user device 101. In one instance, one or more of the modules 109-123 may be implemented for operation by the respective user device 101, as the analysis platform 103. The various executions presented herein contemplate any and all arrangements and models.

### Exemplary Geotagged Data Analysis and Risk Prediction Flowchart

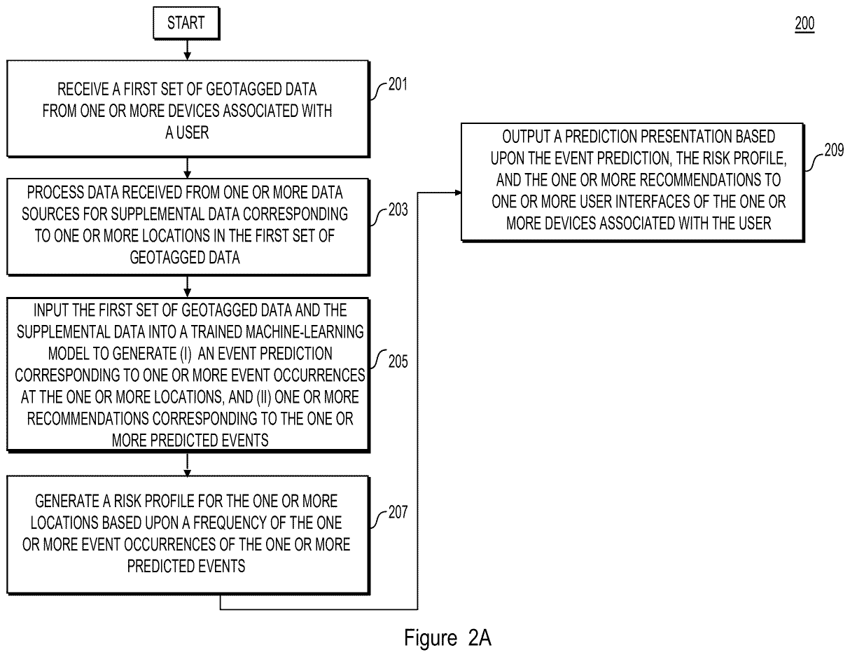

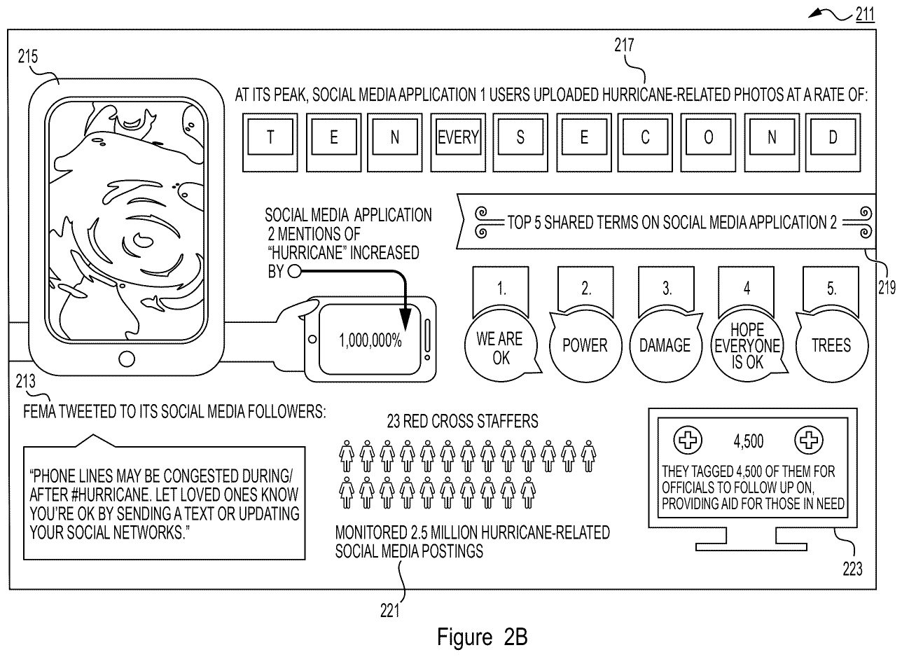

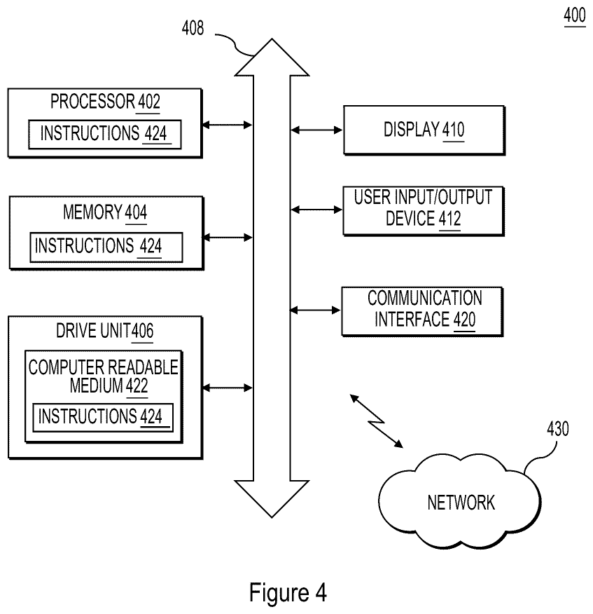

FIG. 2A is an exemplary flowchart of a computer-implemented or computer-based process for analyzing geotagged data for generating predictions and recommendations. In one instance, the analysis platform 103 and/or any of the modules 109-123 may perform one or more portions of the process 200 and are implemented using, for instance, a chip set including a processor (e.g., processor 402) and a memory (e.g., memory 404) as shown in FIG. 4. As such, the analysis platform 103 and/or any of the modules 109-123 may be configured to facilitate accomplishing various parts of the process 200, as well as accomplishing embodiments of other processes described herein in conjunction with other components of the computing system 100. Although the process 200 is illustrated and described as a sequence of actions, operations, and/or functionality, it is contemplated that various embodiments of the process 200 may be performed in any order or combination and need not include all of the illustrated actions, operations, and/or functionality.

In block 201, the analysis platform 103 may receive (e.g., in real-time) a first set of geotagged data from one or more devices (e.g., user device 101) associated with a user. The user may input the geotagged data to the analysis platform 103 via a user device (e.g., user device 101). In some embodiments, the user may select previously stored geotagged data (e.g., stored upon the user device 101) and upload such geotagged data to the analysis platform 103. Alternatively, the analysis platform 103 may automatically gather the geotagged data from a user account or profile (e.g., a social media post) that is associated with the user and/or the user device. The analysis platform 103 may store the received geotagged data in one or more data stores.

In one example, the geotagged data may include one or more videos, one or more images, one or more audio recordings, one or more textual descriptions, and/or timestamp data associated with one or more locations (e.g., “geotagged”). The videos may correspond to video data of an event, weather, and the like. The images may correspond to image data that was captured and/or stored by the user device. The audio recordings may correspond to audio data that captures an event.

Additionally, the textual descriptions may correspond to text that the user input via the user device and/or text associated with a video and/or image. For example, the textual description may correspond to the text that is associated with a social media post (e.g., a hashtag, a description) or text that is not associated with a social media post (e.g., a tweet). The timestamp data may correspond to a date and/or time of when the videos, images, audio recording, and/or textual descriptions were captured. Some or all of the above-described forms of data may include one or more locations that are associated with a particular event, occurrence, weather, and the like.

In block 203, the analysis platform 103 may process data received from one or more data sources (e.g., database 105, data sources 107) for supplemental data corresponding to one or more locations in the first set of geotagged data. The analysis platform 103 may process the geotagged data to determine the type of geotagged data (e.g., video data, image data, etc.). Additionally, or alternatively, the analysis platform 103 may process the geotagged data to determine one or more locations associated with the geotagged data. The analysis platform may select the one or more data sources based upon the type of geotagged data and/or the one or more associated locations. For example, if the geotagged data includes videos of a tornado near Oklahoma City, the analysis platform 103 may select one or more data sources that may include data related to tornados and/or data that may include videos of Oklahoma City.

In one example, the supplemental data may include environmental data, natural disaster data, incident data, and/or historical claims data associated with one or more locations. The environmental data may correspond to weather data, city data, and the like. The natural disaster data may correspond to hurricane data, tornado data, earthquake data, flood data, and the like. The incident data may correspond to emergency data, and the like. The historical claims data may correspond to historical insurance claims, and the like.

In block 205, the analysis platform 103 may input the first set of geotagged data and the supplemental data into a trained machine-learning model. In response to receiving the first set of geotagged data and the supplemental data, the trained machine-learning model may generate (i) an event prediction corresponding to one or more event occurrences at one or more locations and/or (ii) one or more recommendations corresponding to one or more predicted events. The event prediction may describe the likelihood, timing, location, and/or potential impact of specific events or occurrences, such as natural disasters, safety incidents, infrastructure disruptions, or other risk-relevant scenarios based upon patterns identified in the geotagged data and supplemental data.

In one example, the one or more recommendations may include (i) a safety measure recommendation that may provide one or more safety measures to the user, (ii) an advisory recommendation that may advise one or more users to take one or more preventive actions, (iii) an installation recommendation that may recommend an installation of one or more safety devices, and/or (iv) a prompting recommendation that may prompt the one or more users to monitor one or more specific environmental conditions.

In one instance, the analysis platform 103 may process, utilizing the trained machine-learning model, the first set of geotagged data to determine one or more real-time events at one or more locations. The trained machine-learning model may process the supplemental data for one or more prior instances of one or more events (e.g., natural disaster(s), incident(s), etc.) at one or more locations.

The trained machine-learning model may compare (i) one or more real-time events of the geotagged data and (ii) prior instances of one or more events against one or more learned patterns derived from one or more historical events associated with one or more locations or at least one similar geographic region. For example, the trained machine-learning model may access one or more data stores that may include the one or more learned patterns, where the one or more learned patterns may correspond to previous output. The trained machine-learning model may receive the previously output learned patterns as input that is used for the analysis in view of the one or more real-time events of the geotagged data. Exemplary output data may include an updated learned pattern. An event prediction may be generated by the trained machine-learning model based upon the comparison. The event prediction may include a potential occurrence forecast, a severity, and/or an impact of one or more events at one or more locations.

In one instance, the analysis platform 103 may recalibrate, utilizing the trained machine-learning model, the event prediction by processing the first set of geotagged data and the supplemental data for one or more deviations or one or more anomalies. In this instance, the trained machine-learning model may undergo recalibration based upon deviations identified between the processed results and a documented baseline or expected result. When the first set of geotagged data and the supplemental data are fed into the trained machine-learning model, the trained machine-learning model may compare the output prediction to the pre-established results or historical benchmarks. If the processed result deviates from the expected output, it may signal the presence of anomalies, such as unusual patterns in the data or unforeseen events. The deviations may serve as a trigger for the trained machine-learning model to recognize that the input conditions may have changed or that an outlier event is occurring.

The trained machine-learning model may recalibrate the event prediction based upon one or more deviations and/or one or more anomalies. The trained machine-learning model may adjust its weights and parameters based upon the difference between the expected and actual outcomes. For example, if an unexpected weather event may cause a deviation in the risk prediction (e.g., a sudden storm impacting a region that was not initially predicted), the trained machine-learning model may learn from this anomaly, adjusting its internal mechanisms to better predict similar events in the future. This iterative process of recalibration, based upon ongoing comparison between processed data and historical results may ensure that the trained machine-learning model becomes increasingly accurate in its predictions over time, adapting to new and evolving data patterns.

In one instance, the analysis platform 103 may cluster a second set of geotagged data associated with one or more neighboring locations within a proximity threshold of one or more locations. The second set of geotagged data may include additional data (e.g., text posts, images, videos, and audio clips) associated with locations geographically close to the location of the first set of geotagged data. The second set of data may represent data from surrounding areas, providing a more comprehensive understanding of the event or context within that region. For example, if the first set of geotagged data may include data from a particular disaster event, the second set of geotagged data may include data from nearby towns, capturing related activities, sentiments, or real-time observations. The second set of geotagged data may be received dynamically from various data sources (e.g., social media platforms, IoT devices, or external databases), and may be inputted directly by the users or retrieved automatically based upon the predefined geographic scope.

In one instance, the analysis platform 103 may retrieve supplemental data associated with the second set of geotagged data from external data sources (e.g., data source 107). By incorporating the supplemental data, the analysis platform 103 may understand the dynamics of the second set and how they influence the risk predictions and event assessment.

In one instance, the proximity threshold may be determined based upon various factors, such as but not limited to:
(i) Disaster response scenarios: threshold may be narrower to capture data from locations immediately surrounding an event;
(ii) General monitoring or trend analysis: a broader threshold to encompass a larger area and identify patterns over a wider geographic range;
(iii) Population density: threshold may be narrower for densely populated regions to avoid data overload and to ensure that localized events are captured effectively; and/or
(iv) Type of events: weather-related events may trigger a dynamic threshold based upon the severity of the event which may require real-time updates from surrounding regions to assess its impact.

The analysis platform 103 may process the clustered second set of geotagged data to identify one or more regions in one or more neighboring locations with similar event patterns to one or more predicted events in one or more locations. Similar event patterns may be inputted into the trained machine-learning model, whereupon the trained machine-learning model may process similar event patterns while generating the event prediction.

In one instance, the analysis platform 103 may receive a third set of geotagged data from one or more other users within one or more locations. The third set of geotagged data may include additional data (e.g., text posts, images, videos, and audio clips) associated with users (e.g., neighboring users) within the location associated with the first set of geotagged data. The third set of geotagged data may be received dynamically from various data sources (e.g., social media platforms, IoT devices, or external databases), and may be inputted directly by the users or retrieved automatically based upon the location associated with the first set of geotagged data. In one example, the first set of geotagged data may include a social media post, such as photos or general comments from a user in the area reporting the wildfire. The third set of geotagged data may be received or retrieved from other users in the same location, contributing to real-time updates specific to wildfire (e.g., a user uploads a live-streamed video showing flames approaching a nearby road, other users with a connected IoT device may provide localized temperature readings, etc.).

The analysis platform 103 may process the third set of geotagged data to calculate a score. The score may be based upon spatial proximity and temporal frequency of event-related data derived from the third set of geotagged data. In one example, spatial proximity may be determined by clustering nearby data points using location coordinates and assigning weights based upon cluster density and average distances. In one example, temporal frequency may be derived by counting the events within specific time windows and weighting clusters based upon event distribution and intensity.

The calculated score, reflecting spatial proximity and temporal frequency, may be inputted into the machine-learning model to calibrate one or more predicted events. Such calibration may adjust the output of the machine-learning model by providing a real-time, location-specific understanding of event likelihood. For example, if geotagged data indicate frequent and clustered reports of flooding in a specific area, the score derived from these reports may be used to refine the machine-learning model's prediction of flood-related risks. By integrating these scores, the machine-learning model may provide predictions that are not only tailored to individual inputs but also informed by collective, real-world dynamics.

In one instance, the analysis platform 103 may apply sentiment analysis to the geotagged data (e.g., videos, audio recordings, or textual descriptions). The sentiment analysis may involve determining the emotional tone of text, audio, or video data, and identifying sentiments, such as positive, negative, or neutral. When applied to geotagged data, sentiment analysis may involve analyzing the mood and reactions of individuals within specific locations to provide valuable insights for risk identification, event categorization, and post-event analysis.

In one example, the sentiment analysis may include a video sentiment analysis, an audio sentiment analysis, or a textual sentiment analysis. The video sentiment analysis may evaluate facial expressions or body language to determine emotional stress. The audio sentiment analysis may analyze speech patterns, tone, pitch, speed, volume and/or inflection to detect emotions. The textual sentiment analysis may identify emotional tone from written posts or comments.

The analysis platform 103 may input the sentiment analysis into the trained machine-learning model to calibrate one or more predicted events. In one example, the trained machine-learning model may predict a moderate chance of a hurricane, but the negative sentiments from geotagged data may indicate a heightened concern in the area. The trained machine-learning model may recalibrate the prediction to a higher likelihood of a hurricane.

Additionally, after the trained machine-learning model generates initial predictions, the predicted events may be stored in a database (e.g., database 105) for future reference. When sentiment analysis is applied to new geotagged data, the analysis platform 103 may retrieve the stored predicted events and integrate the sentiment scores into the existing predictions. The sentiment data may facilitate recalibrating the predictions, adjusting the likelihood of certain events based upon real-time emotional responses and contextual insights. Once recalibrated, the updated predictions may be stored back into the database, ensuring a continuous record of both original and adjusted predictions.

In block 207, the analysis platform 103 may generate a risk profile for one or more locations based upon the frequency of one or more event occurrences of one or more predicted events. The risk profile may include probability distributions, severity classifications, historical event patterns, and/or impact forecasts associated with each predicted event, enabling a nuanced understanding of the risk landscape for the specified location.

The analysis platform 103 may categorize geotagged data into one or more event categories. The one or more event categories may include a natural disaster category, a public safety incident category, or an infrastructure failure category. The natural disaster category may correspond to events, such as hurricanes, earthquakes, floods, wildfires, tornadoes, and/or tsunamis. The public safety incident category may correspond to events, such as civil unrest, terrorist attacks, mass gatherings, active shooter incidents, or large-scale accidents like train derailments or plane crashes. The infrastructure failure category may correspond to events, such as power outages, water supply disruptions, bridge collapse, road closures, and/or communication network failures.

The analysis platform 103 may assign at least one severity level to each of one or more event categories based upon an event frequency, a geographical impact radius, and/or critical infrastructure proximity. The severity level may include:
(i) High: events with frequent occurrences, wide geographic impact, and/or proximity to critical infrastructure;
(ii) Medium: events with moderate frequency, limited geographical impact, and/or some proximity to critical infrastructure; and/or
(ii) Low: events with infrequent occurrences, minimal geographical impact, and/or no direct impact on critical infrastructure.

A location-specific risk score may be calculated by the analysis platform 103 based upon a weighting of the assigned at least one severity level of one or more categorized events.

In block 209, the analysis platform 103 may output a prediction presentation based upon the event prediction, the risk profile, and/or one or more recommendations to one or more user interfaces of one or more devices associated with the user (e.g., user interface 125). The prediction presentation may include one or more of:
(i) Event details: a summary of the predicted event, including its type, estimated time of occurrence, and likely duration;
(ii) Severity assessment: categorization and ranking of the event's severity level, such as low, moderate, or high;
(iii) Geographic impact: A visual map highlighting the affected areas, along with overlays of risk zones and key points of interest;
(iv) Recommended actions: Specific, actionable steps for users to mitigate potential risks, such as evacuation routes or safety precautions;
(v) Supplemental data: relevant data from external sources, such as weather forecasts, IoT device readings, or historical trends; and/or
(vi) Risk profile summary: a concise overview of the risk associated with the location.

In the example, the analysis platform may incentivize users to perform the recommended actions by offering a range of perks, such as (i) discounts upon insurance premiums, (ii) loyalty points that may be redeemed for discounts, services, or financial rewards, and/or (iii) digital badges or certificates for their commitment to proactive risk management.

In various embodiments, the present embodiments may be able to identify high communication traffic—such as an abnormally high amount of social media posts, internet traffic, or the like—associated with a town or area about to be, being, or been negatively impacted by a natural disaster, such as catastrophic event (“CAT event”), such as an area in the path of tornadoes or a hurricane. For instance, if Spring City, TN is hit particularly bad by the remnants of a hurricane (such as by torrential downpours or tornadoes), an abnormal amount of internet chatter related to Spring City or the surrounding areas may be identified by the present embodiments. This surge in digital activity often correlates with growing public awareness, concern, or preparedness efforts related to a disaster in progress or imminent.

The present embodiments may further analyze the context of the chatter, and/or determine if CAT teams, emergency services, police, national guard, other forms of help, etc. should be sent, or diverted, to Spring City. For instance, the system may contextualize the content of the communication being exchanged. By combining sentiment analysis with the detection of communication patterns, the system may refine the understanding of the situation. For example, a surge in posts expressing panic, uncertainty, or request for help may signify a more severe and urgent need for intervention. In the aftermath of CAT events (e.g., hurricanes, wildfires, tornadoes, etc.), time may be of the essence to have emergency workers arrive at the area of need in a timely manner - the present embodiments may facilitate the timely arrival of such assistance to areas in the path or wake of a CAT event, such as by quickly identifying spikes in internet traffic associated with areas, sometimes remote or rural areas, along the path of natural disasters in real-time or near real-time.

### Exemplary Disaster Intel Dashboard

During CAT events such as hurricanes, tornadoes, or torrential rains, the analysis of social media and internet activity may provide critical insights into real-time development, community needs, and areas needing immediate attention. The rapid spread of information through various social media platforms may allow for the timely detection of an emerging crises and a better understanding of the affected population's needs.

The analysis platform 103 may detect surges in communication traffic, particularly from geotagged social media posts, and other internet activity within a specific geographic area. These sudden spikes may often correlate with growing public awareness, concern, or preparation efforts related to an impending or ongoing disaster. For instance, as news of an approaching hurricane spreads, residents may begin posting updates about weather conditions, evacuation plans, or community resources. This increase in activity may be an early indicator of heightened public awareness, which may provide valuable lead time for disaster response.

As the situation escalates, the tone and frequency of the social media posts may shift. Post expressing distress or sharing urgent information, such as flooded streets or blocked roads, may indicate critical area(s) needing immediate attention. By continuously monitoring communication patterns, the analysis platform 103 may serve as a proactive warning mechanism, capturing signals of a developing crises that may have not yet been reported through official channels. This capability may enable emergency services to respond to potential disasters faster and more effectively than traditional methods.

FIG. 2B depicts a diagram showing an exemplary disaster intel dashboard 211 that may aggregate critical data from government agencies, social media platforms, and/or monitoring organizations to provide real-time insights during CAT events. The disaster intel dashboard 211 may include one or more of the following:
1. Government Agency Posts 213: During a hurricane, FEMA may tweet proactive advice such as “Phone lines may be congested during/after the #Hurricane, let loved ones know you are OK by sending a text or updating your social networks.” Such official posts may highlight the growing reliance on digital communication during emergencies, thereby encouraging individuals to use social media platforms to relay their safety status and share updates.
2. Real-time monitoring of the CAT events 215: A dashboard showing the real-time progression of the hurricane using integrated weather data and mapping systems. The dashboard may display the projected trajectory of the hurricane, along with updates on its intensity, wind speed, and affected regions. By continuously receiving data from trusted meteorological sources, the analysis platform 103 may provide a dynamic visualization of the storm's progress, facilitating users and emergency responders to anticipate its impact.
3. Social media application 217: Users may upload hurricane-related photos and/or videos tagged with hashtags like #Hurricane on a social media platform. For example, images documenting rising water levels, damaged homes, or blocked roads may be posted at a rate of 10 photos per second. Such rapid sharing may provide ground-level imagery and situational awareness, complementing data from weather agencies or emergency services.
4. Social media application 219: A mention of a hurricane may spike significantly, for example, by 1,000,000%, indicating a heightened public discourse about the event. This sharp increase in activity may serve as a digital barometer, reflecting the collective awareness and urgency surrounding the situation. By analyzing the geographic distribution of these mentions and associated hashtags, the disaster response team may pinpoint hotspots of concern, such as areas experiencing severe conditions or public distress. Furthermore, an analysis of the top shared terms on social media platforms may provide insight into the public's sentiment and immediate needs. For instance:
   (i) Phrases like “we are OK” may signal safety updates from users reassuring their loved ones or community that they are unharmed;
   (ii) Terms like “power” may highlight widespread outages, providing clues about the extent and location of utility disruptions;
   (iii) Terms like “damage” may indicate the presence of affected infrastructure, such as destroyed homes, roads, or bridges;
   (iv) Expressions like “hope everyone is OK” may reflect concern for the broader community, indicating areas where individuals are monitoring the well-being of others; and/or
   (v) Terms like “trees” may refer to blockages or damage caused by fallen trees, signaling the need for road clearing and debris removal to restore accessibility.
These terms may help responders prioritize resources for power restoration, infrastructure repair, and direct aid.
6. Monitoring by organization 221: Several organizations, such as the Red Cross, may monitor and analyze large-scale communication traffic during CAT events. For example, during a hurricane, 23 Red Cross staffers may monitor around 2.5 million hurricane related posts to identify critical information. They may identify actionable information by tagging posts, such as calls for help, locations of stranded individuals, or areas needing medical assistance.
7. Follow-up and Aid distribution 223: Out of the 2.5 million posts, around 4,500 were tagged for follow-up by officials. This may enable targeted intervention, ensuring that those in critical need of assistance may receive timely support. For example, someone trapped in a flooded house may post their location on a social media platform, prompting the immediate dispatch of rescue services.

In addition, the analysis platform 103 may analyze the context of the chatter to extract actionable insights. This may involve NLP techniques to identify keywords, phrases, or trends in social media content. For example, posts mentioning rising floodwaters, damaged infrastructure, or overcrowded shelters may provide critical situational details. By tagging and categorizing these posts, the analysis platform 103 may highlight specific issues that may need immediate attention from emergency responders. Furthermore, the analysis platform 103 may cross-reference the geotagged data with external sources (e.g., weather updates, IoT sensors, or traffic data) to verify the urgency and relevance of the situation. For example, a post about a bridge collapse in a town experiencing heavy rainfall may be corroborated by weather data, increasing the system's confidence in recommending resource allocation to that location.

The integration of geotagged social media data into disaster response systems not only accelerates situational awareness but may also bridge the gap between those affected and the responders. By leveraging the ubiquity of social media platforms and the immediacy of user-generated content, this approach may significantly enhance the effectiveness of relief efforts during CAT events.

### Exemplary Machine-Learning Techniques

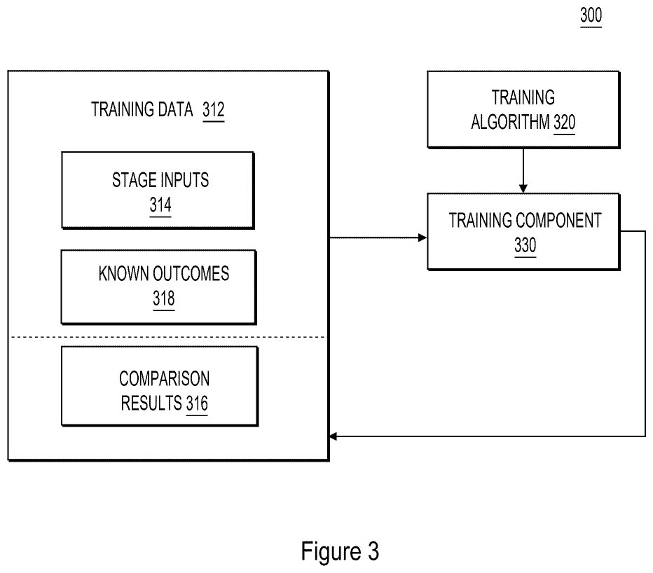

One or more implementations disclosed herein may include and/or may be implemented using a machine-learning model. For example, one or more of the modules of the analysis platform 103 may be implemented using a machine-learning model and/or may be used to train the machine-learning model. A given machine-learning model may be trained using the data flow 300 of FIG. 3. Training data 312 may include one or more of stage inputs 314 and known outcomes 318 related to the machine-learning model to be trained. The stage inputs 314 may be from any applicable source including text, visual representations, data, values, comparisons, stage outputs, e.g., one or more outputs from one or more actions or operations from FIG. 2A. The known outcomes 318 may be included for the machine-learning models generated based upon supervised or semi-supervised training. An unsupervised machine-learning model may not be trained using known outcomes 318. Known outcomes 318 may include known or desired outputs for future inputs similar to, or in the same category as, stage inputs 314 that do not have corresponding known outputs.

The training data 312 and a training algorithm 320, e.g., one or more of the modules implemented using the machine-learning model and/or may be used to train the machine-learning model, may be provided to a training component 330 that may apply the training data 312 to the training algorithm 320 to generate the machine-learning model. According to an implementation, the training component 330 may be provided comparison results 316 that compare a previous output of the corresponding machine-learning model to apply the previous result to re-train the machine-learning model. The comparison results 316 may be used by training component 330 to update the corresponding machine-learning model. The training algorithm 320 may utilize machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, models specifically discussed in the present disclosure, or the like.

The machine-learning model used herein may be trained and/or used by adjusting one or more weights and/or one or more layers of the machine-learning model. For example, during training, a given weight may be adjusted (e.g., increased, decreased, removed) based upon training data or input data. Similarly, a layer may be updated, added, or removed based upon training data/and or input data. The resulting outputs may be adjusted based upon the adjusted weights and/or layers.

In general, any process or operation discussed in this disclosure is understood to be computer-implementable, such as the processes illustrated in FIG. 2A may be performed by one or more processors of a computer system as described herein. A process or process action or operation performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

### Exemplary Computing Environment

In general, any process or operation discussed in this disclosure is understood to be computer-implementable, such as the processes illustrated in FIG. 2A and may be performed by one or more processors of a computer system as described herein. A process or process action or operation performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

FIG. 4 illustrates an implementation of a computer system that may execute techniques presented herein. The computer system 400 may include a set of instructions that can be executed to cause the computer system 400 to perform any one or more of the methods or computer based functions disclosed herein. The computer system 400 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

In a networked deployment, the computer system 400 may operate in the capacity of a server or as a client user computer in a server-client user network environment, or as a peer computer system in a peer-to-peer (or distributed) network environment. The computer system 400 can also be implemented as or incorporated into various devices, such as a personal computer (PC), a tablet PC, a Personal Digital Assistant (PDA), a mobile device, a palmtop computer, a laptop computer, a desktop computer, a web appliance, or any other machine capable of executing a set of instructions (sequential or otherwise) that specify actions to be taken by that machine. In a particular implementation, the computer system 400 may be implemented using electronic devices that provide voice, video, or data communication. Further, while the computer system 400 is illustrated as a single system, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a Central Processing Unit (CPU), a Graphics Processing Unit (GPU), or both. The processor 402 may be a component in a variety of systems. For example, the processor 402 may be part of a standard personal computer or a workstation. The processor 402 may be one or more processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 404 may include a cache or random-access memory for the processor 402. In alternative implementations, the memory 404 is separate from the processor 402, such as a cache memory of a processor, the system memory, or other memory.

The memory 404 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the processor 402 executing the instructions stored in the memory 404. The functions, acts, or tasks are independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing, and the like.

As shown, the computer system 400 may further include a display 410, such as a liquid crystal display (LCD), an organic light emitting diode (OLED), a flat panel display, a solid-state display, a cathode ray tube (CRT), a projector, a printer or other now known or later developed display device for outputting determined information. The display 410 may act as an interface for the user to see the functioning of the processor 402, or specifically as an interface with the software stored in the memory 404 or in the drive unit 406.

Additionally or alternatively, the computer system 400 may include an input/output device 412 configured to allow a user to interact with any of the components of the computer system 400. The input/output device 412 may be a number pad, a keyboard, or a cursor control device, such as a mouse, or a joystick, touch screen display, remote control, or any other device operative to interact with the computer system 400.

The computer system 400 may also or alternatively include drive unit 406 implemented as a disk or optical drive. The drive unit 406 may include a computer-readable medium 422 in which one or more sets of instructions 424, e.g., software, can be embedded. Further, instructions 424 may embody one or more of the methods or logic as described herein. The instructions 424 may reside completely or partially within the memory 404 and/or within the processor 402 during execution by the computer system 400. The memory 404 and the processor 402 also may include computer-readable media as discussed above.

In some systems, computer-readable medium 422 may include the set of instructions 424 or receive and execute the set of instructions 424 responsive to a propagated signal so that a device connected to network 430 can communicate voice, video, audio, images, or any other data over the network 430. Further, the set of instructions 424 may be transmitted or received over the network 430 via communication port or interface 420, and/or using bus 408. The communication port or interface 420 may be a part of the processor 402 or may be a separate component. The communication port or interface 420 may be created in software or may be a physical connection in hardware.

The communication port or interface 420 may be configured to connect with a network 430, external media, the display 410, or any other components in computer system 400, or combinations thereof. The connection with the network 430 may be a physical connection, such as a wired Ethernet connection or may be established wirelessly as discussed below. Likewise, the additional connections with other components of the computer system 400 may be physical connections or may be established wirelessly. The network 430 may alternatively be directly connected to the bus 408.

While the computer-readable medium 422 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 422 may be non-transitory, and may be tangible.

The computer-readable medium 422 may include a solid-state memory such as a memory card or other package that houses one or more non-volatile read-only memories. The computer-readable medium 422 can be a random-access memory or other volatile re-writable memory. Additionally or alternatively, the computer-readable medium 422 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations may broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Computer system 400 may be connected to network 430. The network 430 may define one or more networks including wired or wireless networks. The wireless network may be a cellular telephone network, an 802.10, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 430 may include wide area networks (WAN), such as the Internet, local area networks (LAN), campus area networks, metropolitan area networks, a direct connection such as through a Universal Serial Bus (USB) port, or any other networks that may allow for data communication.

The network 430 may be configured to couple one computing device to another computing device to enable communication of data between the devices. The network 430 may generally be enabled to employ any form of machine-readable media for communicating information from one device to another. The network 430 may include communication methods by which information may travel between computing devices.

The network 430 may be divided into sub-networks. The sub-networks may allow access to all of the other components connected thereto or the sub-networks may restrict access between the components. The network 430 may be regarded as a public or private network connection and may include, for example, a virtual private network or an encryption or other security mechanism employed over the public Internet, or the like.

### EXEMPLARY EMBODIMENT

A computer-implemented method for utilizing geotagged data for predictive modeling may be provided. The computer-implemented method may be performed by one or more local or remote processors of a computing system in communication with one or more local or remote data sources. The computer-implemented method may include (1) receiving, by the one or more processors, a first set of geotagged data from one or more devices associated with a user; (2) processing, by the one or more processors, data received from the one or more data sources for supplemental data corresponding to one or more locations in the first set of geotagged data; (3) inputting, by the one or more processors, the first set of geotagged data and the supplemental data into a machine-learning model, wherein the machine-learning model may be trained to generate (i) an event prediction corresponding to one or more event occurrences at the one or more locations, and/or (ii) one or more recommendations corresponding to the one or more predicted events; (4) generating, by the one or more processors, a risk profile for the one or more locations based upon a frequency of the one or more event occurrences of the one or more predicted events; and/or (5) outputting, by the one or more processors, a prediction presentation based upon the event prediction, the risk profile, and the one or more recommendations to one or more user interfaces of the one or more devices associated with the user.

In some embodiments, the voice bots or chatbots may be configured to utilize AI and/or ML techniques, such as for input or output devices. For instance, a voice bot or chatbot may be a ChatGPT chatbot, an InstructGPT bot, a Codex bot, or a Google Bard bot. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT, InstructGPT bot, Codex bot, or Google Bard bot.

In certain aspects, the event prediction corresponding to the one or more event occurrences at the one or more locations may include (i) processing, by the machine-learning model, the first set of geotagged data to determine one or more real-time events at the one or more locations; (ii) processing, by the machine-learning model, the supplemental data for one or more prior instances of one or more events at the one or more locations, wherein the one or more events may include one or more natural disasters or one or more incidents; (iii) comparing, by the machine-learning model, (a) the one or more real-time events and/or (b) the prior instances of the one or more events to one or more learned patterns derived from one or more historical events associated with the one or more locations or at least one similar geographic region; and/or (iv) generating, by the machine-learning model, the event prediction based upon the comparison, wherein the event prediction may include (a) a potential occurrence forecast, (b) a severity, and/or (c) an impact of the one or more events at the one or more locations.

In various embodiments, the comparison may include (i) processing, by the machine-learning model, the first set of geotagged data and the supplemental data for one or more deviations or one or more anomalies; and/or (ii) recalibrating, by the machine-learning model, the event prediction based upon the one or more deviations or the one or more anomalies.

In certain embodiments, generating the event prediction may include (i) clustering, by the one or more processors, a second set of geotagged data associated with one or more neighboring locations within a proximity threshold of the one or more locations; (ii) processing, by the one or more processors, the clustered second set of geotagged data to identify one or more regions in the one or more neighboring locations with one or more similar event patterns to the one or more predicted events in the one or more locations; and/or (iii) inputting, by the one or more processors, the similar event patterns into the machine-learning model, wherein the machine-learning model may process the similar event patterns during generating the event prediction.

In some embodiments, generating the event prediction may include (i) receiving, by the one or more processors, a third set of geotagged data from one or more other users within the one or more locations; (ii) processing, by the one or more processors, the third set of geotagged data from the one or more other users to calculate a score, wherein the score may be based upon spatial proximity and temporal frequency of event-related data derived from the third set of geotagged data; and/or (iii) inputting, by the one or more processors, the score into the machine-learning model to calibrate the one or more predicted events.

Additionally or alternatively, the geotagged data may include (i) one or more videos, (ii) one or more images, (iii) one or more audio recordings, (iv) one or more textual descriptions, and/or (v) timestamp data associated with the one or more locations.

In certain aspects, calibrating the one or more predicted events may include (i) applying, by the one or more processors, a sentiment analysis to the one or more videos, the one or more audio recordings, or the one or more textual descriptions; and/or (ii) inputting, by the one or more processors, the sentiment analysis into the machine-learning model to calibrate the one or more predicted events.

Additionally or alternatively, the sentiment analysis may include (i) a video sentiment analysis, (ii) an audio sentiment analysis, and/or (iii) a textual sentiment analysis. The video sentiment analysis may evaluate facial expressions and/or body language to determine emotional stress. The audio sentiment analysis may analyze speech patterns, tone, and/or inflection to detect emotions. The textual sentiment analysis may identify emotional tone from written posts or comments.

In some embodiments, generating the risk profile for the one or more locations may include (i) categorizing, by the one or more processors, the geotagged data into one or more event categories, wherein the one or more event categories may include (a) a natural disaster category, (b) a public safety incident category, and/or (c) an infrastructure failure category; (ii) assigning, by the one or more processors, at least one severity level to each of the one or more event categories based upon (a) the frequency, (b) a geographical impact radius, and/or (c) a critical infrastructure proximity; and/or (iii) calculating, by the one or more processors, a location-specific risk score based upon a weighting of the assigned at least one severity level of the one or more categorized events.

In certain aspects, the supplemental data may include (i) environmental data, (ii) natural disaster data, (iii) incident data, and/or (iv) historical claims data associated with the one or more locations.

In certain embodiments, the one or more recommendations may include (i) a safety measure recommendation that provides one or more safety measures to the user, (ii) an advisory recommendation that advises one or more users to take one or more preventive actions, (iii) an installation recommendation that recommends an installation of one or more safety devices, and/or (iv) a prompting recommendation that prompts the one or more users to monitor one or more specific environmental conditions.

A computer system for utilizing geotagged data for predictive modeling may be provided. The computer system may include one or more processors of a computing system, and at least one non-transitory computer readable medium storing instructions which, when executed by the one or more processors, cause the one or more processors to perform operations. The computer system may perform operations including (1) receiving a first set of geotagged data from one or more devices associated with a user; (2) processing data received from the one or more data sources for supplemental data corresponding to one or more locations in the first set of geotagged data; (3) inputting the first set of geotagged data and the supplemental data into a machine-learning model, wherein the machine-learning model may be trained to generate (i) an event prediction corresponding to one or more event occurrences at the one or more locations, and/or (ii) one or more recommendations corresponding to the one or more predicted events; (4) generating a risk profile for the one or more locations based upon a frequency of the one or more event occurrences of the one or more predicted events; and/or (5) outputting a prediction presentation based upon the event prediction, the risk profile, and the one or more recommendations to one or more user interfaces of the one or more devices associated with the user.

In certain aspects, the event prediction corresponding to the one or more event occurrences at the one or more locations may include (i) processing, by the machine-learning model, the first set of geotagged data to determine one or more real-time events at the one or more locations; (ii) processing, by the machine-learning model, the supplemental data for one or more prior instances of one or more events at the one or more locations, wherein the one or more events may include one or more natural disasters or one or more incidents; (iii) comparing, by the machine-learning model, (a) the one or more real-time events and (b) the prior instances of the one or more events to one or more learned patterns derived from one or more historical events associated with the one or more locations or at least one similar geographic region; and/or (iv) generating, by the machine-learning model, the event prediction based upon the comparison, wherein the event prediction may include (a) a potential occurrence forecast, (b) a severity, and/or (c) an impact of the one or more events at the one or more locations.

In some embodiments, the comparison may include (i) processing, by the machine-learning model, the first set of geotagged data and the supplemental data for one or more deviations or one or more anomalies; and/or (ii) recalibrating, by the machine-learning model, the event prediction based upon the one or more deviations or the one or more anomalies.

In certain embodiments, generating the event prediction may include (i) clustering a second set of geotagged data associated with one or more neighboring locations within a proximity threshold of the one or more locations; (ii) processing the clustered second set of geotagged data to identify one or more regions in the one or more neighboring locations with one or more similar event patterns to the one or more predicted events in the one or more locations; and/or (iii) inputting the similar event patterns into the machine-learning model, wherein the machine-learning model may process the similar event patterns during generating the event prediction.

In various embodiments, generating the event prediction may include (i) receiving a third set of geotagged data from one or more other users within the one or more locations; (ii) processing the third set of geotagged data from the one or more other users to calculate a score, wherein the score may be based upon spatial proximity and temporal frequency of event-related data derived from the third set of geotagged data; and/or (iii) inputting the score into the machine-learning model to calibrate the one or more predicted events.

Additionally or alternatively, the geotagged data may include (i) one or more videos, (ii) one or more images, (iii) one or more audio recordings, (iv) one or more textual descriptions, and/or (v) timestamp data associated with the one or more locations.

A non-transitory computer readable medium for utilizing geotagged data for predictive modeling may be provided. The non-transitory computer readable medium may store instructions which, when executed by one or more processors, cause the one or more processors to perform operations. The one or more processors may perform operations including (1) receiving a first set of geotagged data from one or more devices associated with a user; (2) processing data received from the one or more data sources for supplemental data corresponding to one or more locations in the first set of geotagged data; (3) inputting the first set of geotagged data and the supplemental data into a machine-learning model, wherein the machine-learning model may be trained to generate (i) an event prediction corresponding to one or more event occurrences at the one or more locations, and/or (ii) one or more recommendations corresponding to the one or more predicted events; (4) generating a risk profile for the one or more locations based upon a frequency of the one or more event occurrences of the one or more predicted events; and/or (5) outputting a prediction presentation based upon the event prediction, the risk profile, and the one or more recommendations to one or more user interfaces of the one or more devices associated with the user.

In some embodiments, the event prediction corresponding to the one or more event occurrences at the one or more locations may include (i) processing, by the machine-learning model, the first set of geotagged data to determine one or more real-time events at the one or more locations; (ii) processing, by the machine-learning model, the supplemental data for one or more prior instances of one or more events at the one or more locations, wherein the one or more events may include one or more natural disasters or one or more incidents; (iii) comparing, by the machine-learning model, (a) the one or more real-time events and/or (b) the prior instances of the one or more events to one or more learned patterns derived from one or more historical events associated with the one or more locations or at least one similar geographic region; and/or (iv) generating, by the machine-learning model, the event prediction based upon the comparison, wherein the event prediction may include (a) a potential occurrence forecast, (b) a severity, and/or (c) an impact of the one or more events at the one or more locations.

In certain aspects, the comparison may include (i) processing, by the machine-learning model, the first set of geotagged data and the supplemental data for one or more deviations or one or more anomalies; and/or (ii) recalibrating, by the machine-learning model, the event prediction based upon the one or more deviations or the one or more anomalies.

### Additional Considerations

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the actions, operations, and/or functionality of computer-implemented methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘_______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Finally, unless a claim element is defined by expressly reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied upon a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate upon a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method for utilizing geotagged data for predictive modeling, the computer-implemented method performed by one or more processors of a computing system in communication with one or more data sources, the computer-implemented method comprising:
receiving, by the one or more processors, a first set of geotagged data from one or more devices associated with a user;
processing, by the one or more processors, data received from the one or more data sources for supplemental data corresponding to one or more locations in the first set of geotagged data;
inputting, by the one or more processors, the first set of geotagged data and the supplemental data into a machine-learning model, wherein the machine-learning model is trained to generate (i) an event prediction corresponding to one or more event occurrences at the one or more locations, and (ii) one or more recommendations corresponding to the one or more predicted events;
generating, by the one or more processors, a risk profile for the one or more locations based upon a frequency of the one or more event occurrences of the one or more predicted events; and
outputting, by the one or more processors, a prediction presentation based upon the event prediction, the risk profile, and the one or more recommendations to one or more user interfaces of the one or more devices associated with the user.

2. The computer-implemented method of claim 1, wherein the event prediction corresponding to the one or more event occurrences at the one or more locations, further comprises:
processing, by the machine-learning model, the first set of geotagged data to determine one or more real-time events at the one or more locations;
processing, by the machine-learning model, the supplemental data for one or more prior instances of one or more events at the one or more locations, wherein the one or more events include one or more natural disasters or one or more incidents;
comparing, by the machine-learning model, (i) the one or more real-time events and (ii) the prior instances of the one or more events to one or more learned patterns derived from one or more historical events associated with the one or more locations or at least one similar geographic region; and
generating, by the machine-learning model, the event prediction based upon the comparison, wherein the event prediction includes a potential occurrence forecast, a severity, or an impact of the one or more events at the one or more locations.

3. The computer-implemented method of claim 2, wherein the comparison further comprises:
processing, by the machine-learning model, the first set of geotagged data and the supplemental data for one or more deviations or one or more anomalies; and
recalibrating, by the machine-learning model, the event prediction based upon the one or more deviations or the one or more anomalies.

4. The computer-implemented method of claim 1, further comprising:
clustering, by the one or more processors, a second set of geotagged data associated with one or more neighboring locations within a proximity threshold of the one or more locations;
processing, by the one or more processors, the clustered second set of geotagged data to identify one or more regions in the one or more neighboring locations with one or more similar event patterns to the one or more predicted events in the one or more locations; and
inputting, by the one or more processors, the similar event patterns into the machine-learning model, wherein the machine-learning model processes the similar event patterns during generating the event prediction.

5. The computer-implemented method of claim 1, further comprising:
receiving, by the one or more processors, a third set of geotagged data from one or more other users within the one or more locations;
processing, by the one or more processors, the third set of geotagged data from the one or more other users to calculate a score, wherein the score is based upon spatial proximity and temporal frequency of event-related data derived from the third set of geotagged data; and
inputting, by the one or more processors, the score into the machine-learning model to calibrate the one or more predicted events.

6. The computer-implemented method of claim 1, wherein the geotagged data includes one or more videos, one or more images, one or more audio recordings, one or more textual descriptions, or timestamp data associated with the one or more locations.

7. The computer-implemented method of claim 6, further comprising:
applying, by the one or more processors, a sentiment analysis to the one or more videos, the one or more audio recordings, or the one or more textual descriptions; and
inputting, by the one or more processors, the sentiment analysis into the machine-learning model to calibrate the one or more predicted events.

8. The computer-implemented method of claim 7, wherein the sentiment analysis includes a video sentiment analysis, an audio sentiment analysis, or a textual sentiment analysis, wherein the video sentiment analysis evaluates facial expressions or body language to determine emotional stress, wherein the audio sentiment analysis analyzes speech patterns, tone, or inflection to detect emotions, and wherein the textual sentiment analysis identifies emotional tone from written posts or comments.

9. The computer-implemented method of claim 1, wherein generating the risk profile for the one or more locations, further comprises:
categorizing, by the one or more processors, the geotagged data into one or more event categories, wherein the one or more event categories include a natural disaster category, a public safety incident category, or an infrastructure failure category;
assigning, by the one or more processors, at least one severity level to each of the one or more event categories based upon the frequency, a geographical impact radius, or a critical infrastructure proximity; and
calculating, by the one or more processors, a location-specific risk score based upon a weighting of the assigned at least one severity level of the one or more categorized events.

10. The computer-implemented method of claim 1, wherein the supplemental data includes environmental data, natural disaster data, incident data, or historical claims data associated with the one or more locations.

11. The computer-implemented method of claim 1, wherein the one or more recommendations include (i) a safety measure recommendation that provides one or more safety measures to the user, (ii) an advisory recommendation that advises one or more users to take one or more preventive actions, (iii) an installation recommendation that recommends an installation of one or more safety devices, or (iv) a prompting recommendation that prompts the one or more users to monitor one or more specific environmental conditions.

12. A computer system for utilizing geotagged data for predictive modeling, comprising:
one or more processors of a computing system in communication with one or more data sources; and
at least one non-transitory computer readable medium storing instructions which, when executed by the one or more processors, cause the one or more processors to perform operations comprising:
receiving a first set of geotagged data from one or more devices associated with a user;
processing data received from the one or more data sources for supplemental data corresponding to one or more locations in the first set of geotagged data;
inputting the first set of geotagged data and the supplemental data into a machine-learning model, wherein the machine-learning model is trained to generate (i) an event prediction corresponding to one or more event occurrences at the one or more locations, and (ii) one or more recommendations corresponding to the one or more predicted events;
generating a risk profile for the one or more locations based upon a frequency of the one or more event occurrences of the one or more predicted events; and
outputting a prediction presentation based upon the event prediction, the risk profile, and the one or more recommendations to one or more user interfaces of the one or more devices associated with the user.

13. The system of claim 12, wherein the event prediction corresponding to the one or more event occurrences at the one or more locations, further comprises:
processing, by the machine-learning model, the first set of geotagged data to determine one or more real-time events at the one or more locations;
processing, by the machine-learning model, the supplemental data for one or more prior instances of one or more events at the one or more locations, wherein the one or more events include one or more natural disasters or one or more incidents;
comparing, by the machine-learning model, (i) the one or more real-time events and (ii) the prior instances of the one or more events to one or more learned patterns derived from one or more historical events associated with the one or more locations or at least one similar geographic region; and
generating, by the machine-learning model, the event prediction based upon the comparison, wherein the event prediction includes a potential occurrence forecast, a severity, or an impact of the one or more events at the one or more locations.

14. The system of claim 13, wherein the comparison further comprises:
processing, by the machine-learning model, the first set of geotagged data and the supplemental data for one or more deviations or one or more anomalies; and
recalibrating, by the machine-learning model, the event prediction based upon the one or more deviations or the one or more anomalies.

15. The system of claim 12, further comprising:
clustering a second set of geotagged data associated with one or more neighboring locations within a proximity threshold of the one or more locations;
processing the clustered second set of geotagged data to identify one or more regions in the one or more neighboring locations with one or more similar event patterns to the one or more predicted events in the one or more locations; and
inputting the similar event patterns into the machine-learning model, wherein the machine-learning model processes the similar event patterns during generating the event prediction.

16. The system of claim 12, further comprising:
receiving a third set of geotagged data from one or more other users within the one or more locations;
processing the third set of geotagged data from the one or more other users to calculate a score, wherein the score is based upon spatial proximity and temporal frequency of event-related data derived from the third set of geotagged data; and
inputting the score into the machine-learning model to calibrate the one or more predicted events.

17. The system of claim 12, wherein the geotagged data includes one or more videos, one or more images, one or more audio recordings, one or more textual descriptions, or timestamp data associated with the one or more locations.

18. A non-transitory computer readable medium for utilizing geotagged data for predictive modeling, the non-transitory computer readable medium storing instructions which, when executed by one or more processors of a computing system in communication with one or more data sources, cause the one or more processors to perform operations comprising:
receiving a first set of geotagged data from one or more devices associated with a user;
processing data received from the one or more data sources for supplemental data corresponding to one or more locations in the first set of geotagged data;
inputting the first set of geotagged data and the supplemental data into a machine-learning model, wherein the machine-learning model is trained to generate (i) an event prediction corresponding to one or more event occurrences at the one or more locations, and (ii) one or more recommendations corresponding to the one or more predicted events;
generating a risk profile for the one or more locations based upon a frequency of the one or more event occurrences of the one or more predicted events; and
outputting a prediction presentation based upon the event prediction, the risk profile, and the one or more recommendations to one or more user interfaces of the one or more devices associated with the user.

19. The non-transitory computer readable medium of claim 18, wherein the event prediction corresponding to the one or more event occurrences at the one or more locations, further comprises:
processing, by the machine-learning model, the first set of geotagged data to determine one or more real-time events at the one or more locations;
processing, by the machine-learning model, the supplemental data for one or more prior instances of one or more events at the one or more locations, wherein the one or more events include one or more natural disasters or one or more incidents;
comparing, by the machine-learning model, (i) the one or more real-time events and (ii) the prior instances of the one or more events to one or more learned patterns derived from one or more historical events associated with the one or more locations or at least one similar geographic region; and
generating, by the machine-learning model, the event prediction based upon the comparison, wherein the event prediction includes a potential occurrence forecast, a severity, or an impact of the one or more events at the one or more locations.

20. The non-transitory computer readable medium of claim 19, wherein the comparison further comprises:
processing, by the machine-learning model, the first set of geotagged data and the supplemental data for one or more deviations or one or more anomalies; and
recalibrating, by the machine-learning model, the event prediction based upon the one or more deviations or the one or more anomalies.
